(19) United States
(12) Patent Application Publication
(10) Pub. No.: US 2008/0034040 A1
(43) Pub. Date: Feb. 7, 2008

(54) METHOD AND SYSTEM FOR EMBEDDED GROUP COMMUNICATION

(75) Inventors: Elaine Wherry, San Jose, CA (US); Sandy Jen, Menlo Park, CA (US); Seth Sternberg, San Francisco, CA (US); Jian Shen, E. Palo Alto, CA (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(73) Assignee: Meebo, Inc.

(21) Appl. No.: 11/834,562

(22) Filed: Aug. 6, 2007

Related U.S. Application Data
(60) Provisional application No. 60/822,608, filed on Aug. 16, 2006.
(60) Provisional application No. 60/867,999, filed on Nov. 30, 2006.
(60) Provisional application No. 60/886,466, filed on Jan. 24, 2007.
(60) Provisional application No. 60/821,496, filed on Aug. 4, 2006.

(51) Int. Cl. G06F 15/16

(52) U.S. Cl. 709/204; 709/203

(57) ABSTRACT

A method and system for embedded group communications are disclosed. According to one embodiment, a computer-implemented method comprises providing software code to be embedded in a website. The website is loaded including the embedded software code. A configuration file is fetched from a configuration server in response to loading the embedded software code. The embedded software code renders a group chat room.

The present application claims the benefit of and priority to U.S. Provisional Patent Application No. 60/822,496 entitled “A Method and System for Embedded Group Communication” and filed on Aug. 4, 2006, and is hereby, incorporated by reference. The present application further claims the benefit of and priority to U.S. Provisional Patent Application No. 60/867,999 entitled “A Method and System for Embedded Group Communication With Dynamic Advertising” and filed on Nov. 30, 2006, and is hereby, incorporated by reference. The present application further claims the benefit of and priority to U.S. Provisional Patent Application No. 60/886,466 entitled “A Method and System for Embedded Group Communication With A Dynamic Media Player” and filed on Jan. 24, 2007, and is hereby, incorporated by reference. The present application further claims the benefit of and priority to U.S. Provisional Patent Application No. 60/822,608 entitled “A Method and System for Embedded Group Communication” and filed on Aug. 16, 2006, and is hereby, incorporated by reference.

### TECHNICAL FIELD

The field of the invention relates generally to computer systems and more particularly relates to a method and system for embedded personalized communication.

### BACKGROUND

Instant Messaging (sometimes referred to as IM) enables users to easily see whether a chosen buddy (e.g., a friend, colleague, co-worker or the like) is connected to the Internet and, if so, to exchange messages with them. Instant Messaging differs from common e-mail in the immediacy of the message exchange. Typically, IM exchanges are text-only. However, some services (e.g., AOL Instant Messaging) enable voice messaging and file sharing. In IM, both users need to subscribe to the service (e.g., download and install certain software on their user devices), and need to be online at the same time. In addition, the intended recipient needs to be willing to accept instant messages. If one tries to send an IM to someone who is not online, or who is not willing to accept an Instant Message, a notification is typically provided that the transmission cannot be completed. If the recipient's online software is set to accept Instant Messages, it typically alerts the recipient with a distinctive sound and displays a Pop-Up window that indicates that an IM has arrived, and that enables the recipient to accept or reject it, or displays a Pop-up window containing the incoming message. In general, IM can be truly or virtually instantaneous (with, e.g., delays of usually less than a number of seconds), such that it is typically possible for two people to have a real-time online “conversation” by sending IMs to each other.

IM users typically use a networked computer and IM client software to exchange messages with one another in conversational style. An IM client provides an interface for users to compose, send, receive, and read text messages. Examples of IM clients that are popular today include IBM's SAMETIME, MSN MESSENGER, YAHOO! INSTANT MESSENGER, and AOL INSTANT MESSENGER.

In a graphical display, an IM client provides windows through which a user can compose and read messages. IM clients provide users the ability to manage lists of contacts, particularly other IM users. These lists are referred to as “buddy lists.” Users may organize buddy lists into groups of related users, where the IM client displays the various groups in a hierarchical tree that can be collapsed and expanded as the user desires.

A chat room is a form of synchronous conferencing, occasionally even asynchronous conferencing. It may take the form of real-time online chat over instant messaging, online forums, fully immersive graphical social environment, etc. When instant messaging is used, IM users often conduct one on one conversations with people in a users “buddy list.” IM users may also engage in the same conversations with multiple people. Typically in a chat room enabled by IM, participation is enabled when an IM user joins a chat room from one application and/or website where the group chat room interface resides. The group chat room is supported by the server that supports the application and/or website.

### SUMMARY

A method and system for embedded group communications are disclosed. According to one embodiment, a computer-implemented method comprises providing software code to be embedded on a website. The website is loaded including the embedded software code. A configuration file is fetched from a configuration server in response to loading the embedded software code. The embedded software code renders a group chat room.

The above and other preferred features, including various novel details of implementation and combination of elements, will now be more particularly described with reference to the accompanying drawings and pointed out in the claims. It will be understood that the particular methods and systems described herein are shown by way of illustration only and not as limitations. As will be understood by those skilled in the art, the principles and features described herein may be employed in various and numerous embodiments without departing from the scope of the teachings herein.

### BRIEF DESCRIPTION OF THE DRAWINGS

The accompanying drawings, which are included as part of the present specification, illustrate the presently preferred embodiment of the present invention and together with the general description given above and the detailed description of the preferred embodiment given below serve to explain and teach the principles of the present invention.

FIG. 1 illustrates a block diagram of an exemplary peer-to-peer group communication system, according to one embodiment;

FIG. 2 illustrates an exemplary computer architecture for use with the group communications system, according to one embodiment;

FIG. 3 illustrates a flow diagram of an exemplary process to create an embedded group communication widget, according to one embodiment.

FIG. 4 illustrates a flow diagram of an exemplary process for a user to join a group chat room, according to one embodiment;

FIG. 5 illustrates a flow diagram of an exemplary process for the group communications to proceed through copies of the same group communications widget, according to one embodiment;

FIG. 6 illustrates a block diagram of an exemplary peer-to-peer group communication system with dynamic media playing, according to one embodiment;

FIG. 7 illustrates a flow diagram of an exemplary process for delivering real-time dynamic media in a group chat room, according to one embodiment;

FIG. 8 illustrates an exemplary user interface for delivering real-time dynamic media, according to one embodiment;

FIG. 9 illustrates an exemplary system for an exemplary peer-to-peer group communication system with dynamic advertising, according to one embodiment;

FIG. 10 illustrates a flow diagram of an exemplary process for providing advertising data to a group chat room, according to one embodiment; and

FIG. 11 illustrates a flow diagram of an exemplary process for the advertisers to acquire advertising space in a group chat room or time slots within the group chat room to conduct real-time dynamic advertising, according to one embodiment.

### DETAILED DESCRIPTION

A method and system for embedded group communication are disclosed. According to one embodiment, a computer-implemented method comprises providing software code to be embedded on a website. The website is loaded including the embedded software code. A configuration file is fetched from a configuration server in response to loading the embedded software code. The embedded software code renders a group chat room.

In the following description, for purposes of explanation, specific nomenclature is set forth to provide a thorough understanding of the various inventive concepts disclosed herein. However, it will be apparent to one skilled in the art that these specific details are not required in order to practice the various inventive concepts disclosed herein.

The present invention also relates to apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories, random access memories, EPROMs, EEPROMs, magnetic or optical cards, or any type of media suitable for storing electronic instructions, and each coupled to a computer system bus.

The methods presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

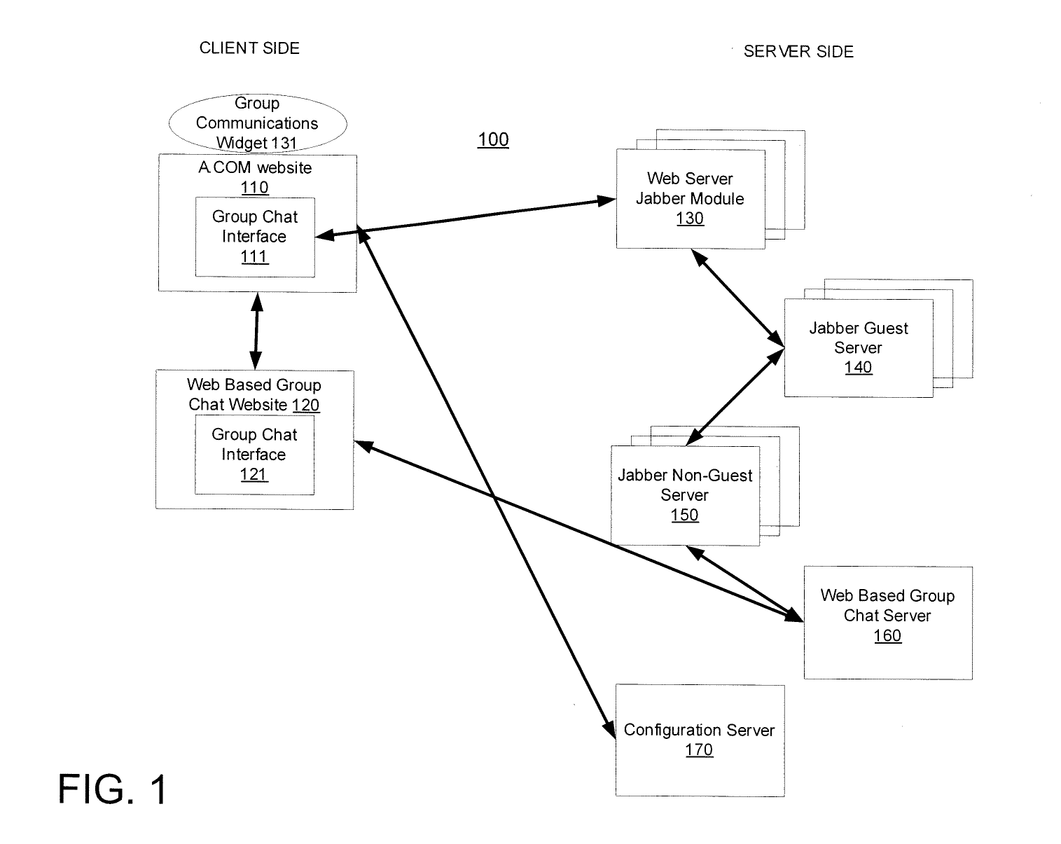

FIG. 1 illustrates a block diagram of an exemplary peer-to-peer group communication system, according to one embodiment. Embedded group communication refers to any messaging capability that allows communication between multiple users on multiple websites or applications, during a common IM session.

Embedded group communications system 100 is divided into a client side and a server side. The client side includes web-based group chat website 120, where the initial group chat interface 121 resides. Non-guest users and guest users may join group chat through interface 121 on website 120, which is hosted by the group chat server 160.

The client side also includes website A.COM that may be accessible through a web browser. Website A.COM 110 includes embedded group communication widget 131. The widget 131 may be software that is embedded on additional websites. When website A.COM is loaded, widget 131 may render a small window interface on website 110 that takes the form of a public chat room on Worldcup soccer, or any other topic. Widget 131 allows an interface similar to group chat interface 121 to appear in website A.COM 110 as group chat interface 111. Interface 111 of widget 131 may afford similar client functionality to that of group chat interface 121, or offer an altogether different set to the user. Widget 131 may be copied to other websites, and each version of the copied widget may be modified for the particular website on which it is embedded. A copy of widget 131 may render another group chat interface on another website as configured by the owner, manager or a user of the website.

Different group chat user interfaces 111, 121 are linked via a shared communication protocol to group chat server 160. A group chat user may send and receive messages in the user interface he uses. The IM communications between different users using different group chat interfaces are synchronized and dynamically updated in real-time. Group chat interfaces 111, 121 allow users to send or receive instant messages, receive presence information, join group chat, leave the group chat, or exchange other similar information with other users in real time. If a user types in a message on interface 121, it shows up on 121 as a message he is entering but appears as a message from this user to another user in interface 111. This message can be in the form of text, images, or any other representation of the received message.

Each interface may have its own look and feel, design, etc. The owner, manager, or a user can select or modify the design of the interface. For example, website A.COM 110 may be user A's profile on MYSPACE.COM. User A's profile is typically rendered by a browser in HTML format which contains the software code that links website A.COM of client 110 to an instant messaging account as viewed on a website 120 for web based group chat. Through this link, a user visiting website A.COM 110 can initiate, receive, and maintain a group chat session with other users on web-based group chat website client 120.

Many websites may be included in this system, with copies of group communication widget 131 embedded in them. Widget 131 and its copies allow group communications interface 121 to be spread to multiple websites or applications, forming a “ring” of chat rooms, in which multiple users may IM one another via a shared chat host from different group chat interfaces. The same conversation hosted on group chat server 160 can thus be accessed from and contributed to by multiple sources, effectively creating a group chat ring.

The server side of embedded communications system 100 communicates with website A.COM on client 110 and web-based group chat website on client 120. According to one embodiment, web server 130 is a LightTPD web server. LightTPD is a web server which is designed to be secure, fast, standards-compliant, and flexible while being optimized for speed-critical environments. Its low memory footprint (compared to other web servers), light CPU load and its speed goals make LightTPD suitable for servers that are suffering load problems, or for serving static media separately from dynamic content. LightTPD is free software/open source, and runs on GNU/Linux and other Unix-like operating systems and Microsoft Windows.

Web server 130 may include a Jabber module that communicates with a guest server 140. Jabber is an instant messaging and group chat technology that utilizes the Extensible Messaging and Presence Protocol (XMPP). In one embodiment, web server 130 communicates with a Jabber guest server 140. Jabber guest server 140 can be instantiated on the same physical server as web server 130, or a separate server altogether. Jabber guest server 140 maintains a database of active group chat clients and includes the capability of offering anonymous subscriptions when requested by web server 130. In one embodiment, the anonymous subscriptions are destroyed once the user disconnects. In this way, subscriptions can be re-used. Jabber guest server 140 may also be queried for presence information of subscribed users.

A non-guest Jabber server 150 communicates with Jabber guest server 140. Jabber non-guest server 150 facilitates instant messaging group chat when users are not anonymous. In other words, Jabber non-guest server 150 communicates with web based group chat server 160 that maintains databases of registered users that have instant messaging accounts, such as the website for web based group chat client 120.

The functionality ascribed to Jabber guest server 140 can also live on Jabber non-guest server 150 and vice versa. In another embodiment, anonymous and registered users could both communicate with the same Jabber server. Communication between anonymous and registered users occurs between the different instantiations on the same server.

In this embodiment, all registered users of group chat server 160 are also logged into Jabber non-guest server 150. When a registered user logs into their account on web server 160, server 160 initiates a group chat session with Jabber non-guest server 150, using credentials stored in the database system controlled by group chat system 160. For the life of the session on group chat user interface 121, web server 160 attempts to keep the user logged into Jabber non-guest server 150. On a potential disconnection, the user is automatically re-connected.

A configuration server 170 stores configuration files that are used to instantiate properties of group chat user interface 111, e.g., rendering, communication details, server-specific information, etc., as well as to uniquely identify or categorize instances of the group chat user interface 111 embedded on multiple websites 110. The HTML code for the group chat user interface 111 specifies which configuration file to load from the configuration server 170. That configuration file stores an identifier chosen by the creator of the embedded group chat user interface 111 so that when a new message is received, the user can immediately recognize the origin of the visitor. This organization is done through the user's buddy list where specific conversation instances are listed under their respective identifiers or “groups” that were chosen during creation.

System 100 is interconnected by the Internet (not shown), alternatively, the network may be a Wide Area Network (WAN), a Local Area Network (LAN), or any other system of interconnections enabling two or more devices to exchange information. Further, the network may include a wireless network, such that one or more of clients 110 or 120 may be wireless devices.

One or more of clients 110 or 120 may allow network access via a web browser such as MICROSOFT'S INTERNET EXPLORER, NETSCAPE BROWSER, MOZILLA, FIREFOX, or the SAFARI browsers that support HTML and JavaScript. Additionally, clients 110 or 120 may be mobile devices, such as videophones, laptops, smart phones, mobile phones, PDAs, game devices such as the PSP manufactured by Sony Electronics, multimedia devices such as iPods and iPhones manufactured by Apple Computers of Cupertino, Calif., or similar devices.

According to one embodiment, server 160 may be a Gaim server such as an open-source GTK2-based instant messenger application (under GPL). It supports multiple protocols via modules, including AIM, ICQ, Yahoo!, MSN, Jabber, IRC, Napster, Gadu-Gadu and Zephyr.

Servers 130-170 run on a number of platforms, including Windows, Linux, and Qtopia (Sharp, Zaurus and iPaq). Gaim server 160 is not endorsed by or affiliated with AOL TimeWarner, Microsoft, or Yahoo. Although Gaim server 160 is described, any multi-protocol server may be used including Pidgin (open source) or Trillian created by Cerulean Studios. According to one embodiment, Gaim server 160 does not include the GTK visual software in order to be optimized as a web server application. In one embodiment, the Gaim server 160 is comprised mostly of back-end functionality and no graphical user interface. Different systems may set limits on how many instant messaging services may be connected, or may be active on one screen.

The processes executed within system 100 may be implemented in software or hardware, or utilizing a device that is, or can be, connected to a common network, such as the Internet. Clients 110, and 120 may be mobile devices or fixed devices such as set top boxes, desktop computers, media recorders such as those manufactured by TiVo, Inc. of Alviso, Calif., game devices such as the XBox manufactured by Microsoft, Corp. of Redmond, Wash. or similar devices.

Web based group chat server 160 enables a web based group chat service that does not require IM or other software to be installed on clients 110, and 120. According to one embodiment, the instant messaging or group chat application is web-based and communication between clients 110, 120 and servers 130-170 take the form of XmlHttpRequests.

Servers 130-170 are web servers that use any one of a number of protocols and/or applications including HyperText Transfer Protocol (HTTP), File Transfer Protocol (FTP), Internet Relay Chat (IRC), etc., via a TCP/IP connection (not shown in this view) or other similar connection protocols. The operating system may be Windows®, LINUX, SUN Solaris®, Mac OS, Tiger, Leopard, or other similar operating system. In one embodiment, the servers 130-170 are dedicated servers. It uses processing logic, tools and databases and is built using a combination of technologies such as those from Apache Software (www.apache.org) such as Tomcat servers; Java based technologies such as J2EE, EJB, JBOSS, JDBC; and/or databases such as MySQL.

System 100 also allows for the determination of a user's web presence, that is identifying the website that a user is visiting on the web and/or the activities, behavior, or other information related to that user while the user is on that site.

System 100 may also include other supporting computing software and hardware, for example, additional website servers, databases, computers, and user interface servers.

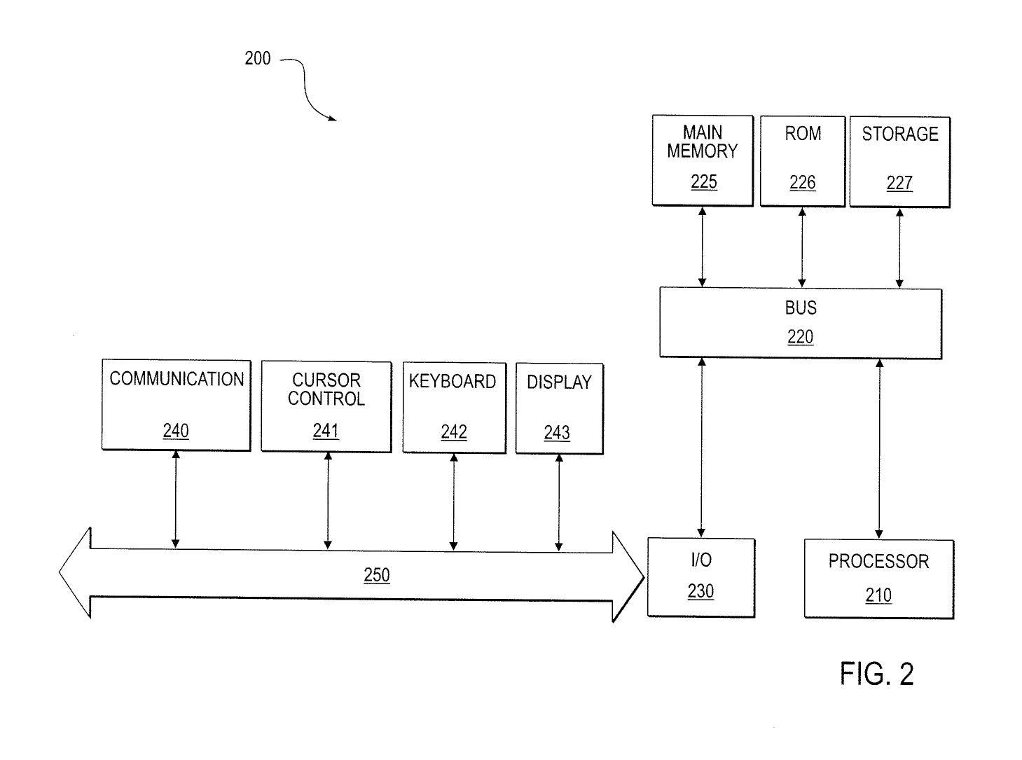

FIG. 2 illustrates an exemplary computer architecture for use with the present system, according to one embodiment. Computer architecture 200 can be used to implement a client 110, 120, or a server 130-170 of FIG. 1. One embodiment of architecture 200 comprises a system bus 220 for communicating information, and a processor 210 coupled to bus 220 for processing information. Architecture 200 further comprises a random access memory (RAM) or other dynamic storage device 225 (referred to herein as main memory), coupled to bus 220 for storing information and instructions to be executed by processor 210. Main memory 225 also may be used for storing temporary variables or other intermediate information during execution of instructions by processor 210. Architecture 200 also may include a read only memory (ROM) and/or other static storage device 226 coupled to bus 220 for storing static information and instructions used by processor 210.

A data storage device 227 such as a magnetic disk or optical disc and its corresponding drive may also be coupled to computer system 200 for storing information and instructions. Architecture 200 can also be coupled to a second I/O bus 250 via an I/O interface 230. A plurality of I/O devices may be coupled to I/O bus 250, including a display device 243, an input device (e.g., an alphanumeric input device 242 and/or a cursor control device 241). For example, web pages rendered by web server 130 and related information may be presented to the user on the display device 243.

The communication device 240 allows for access to other computers (servers or clients) via a network. The communication device 240 may comprise a modem, a network interface card, a wireless network interface or other well known interface device, such as those used for coupling to Ethernet, token ring, or other types of networks.

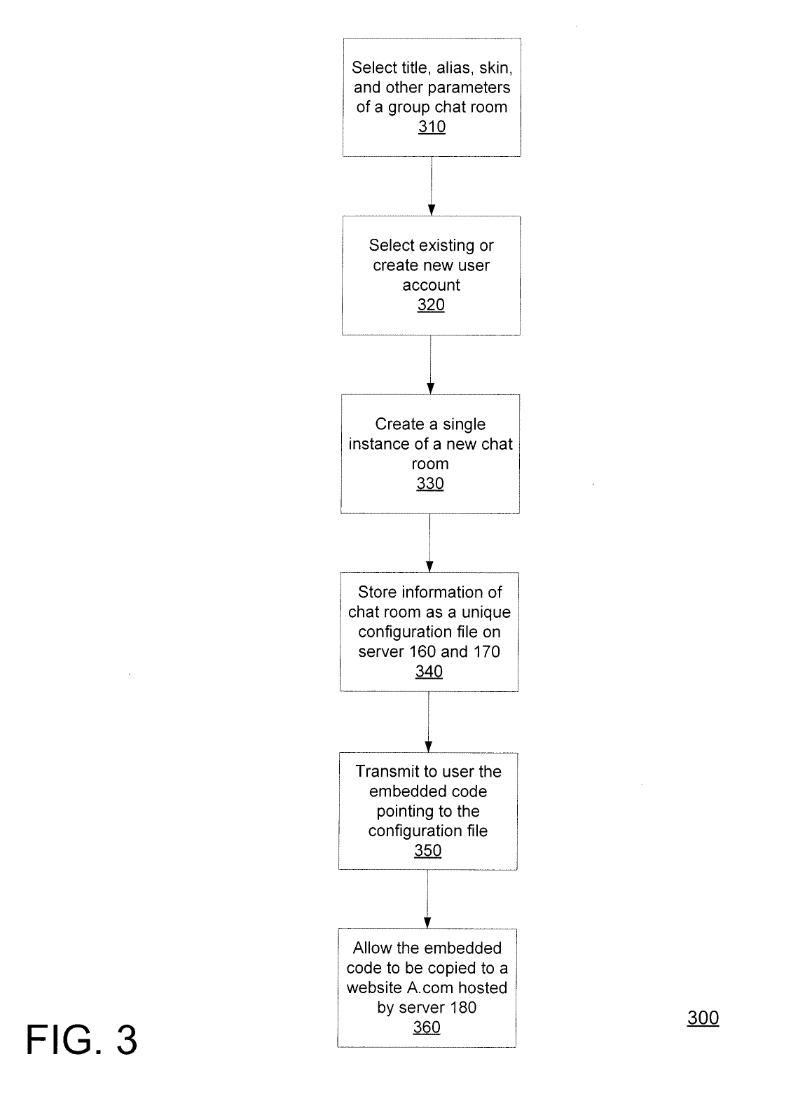

FIG. 3 illustrates a flow diagram of an exemplary process 300 to create an embedded group communication widget, according to one embodiment. Creation process 300 allows an owner of a website (such as website of A.COM 110) to embed code within the website to enable group chat user interface 121. Through web based group chat server 160, a chat room owner is prompted to select design parameters for the group chat user interface 121, such as a title, alias, user interface location, look, and feel, etc (310). The parameters may also include a description of the group chat room, the public or private nature of the chat room, membership requirements, and a maximum number of participants. The owner is then prompted to choose an existing user account or create a new user account on web based group chat server 160 (320). The user account tied to the owner may allow for the ability for group chat modification, moderation, and other related activities. The owner may bestow similar rights to other participants or members of the group chat.

Web based group chat server 160 creates a single instance of group chat room 121, with the parameters selected and a unique URL or address, on web based group chat website 120 (330). Web based group chat server 160 or another server linked to it stores the user provided design parameters, as well as user profile information. Those parameters used for the instantiation of interface 121 are stored in a configuration file on a configuration server 170 (340). Any other group chat parameters may be stored in other database or storage servers and accessed later for purposes of rendering, communicating, configuring, etc. The embedded group communications widget 131 requests the configuration file identifying the design parameters selected by the owner stored on configuration server 170. These configuration parameters may be modified using user interface 121 or some other website associated with the user account that designed the widget.

Web based group chat server 160 automatically generates code that allows the widget to be copied from one website to another web page (350). This code may render a “Copy” button on the group chat user interface 121, where any user may click on this button and copy the embedded code responsible for rendering the widget and enabling communication. The copy of the widget may be embedded in a personal website or blog, or a public website (360). Widget 131 may be updated by chat server 160 with additional code, such as software code that enables a media player, gaming playing, advertising, or other applications or information. The communication mechanism of the additional code or application within the widget may or may not use the same protocol as the IM communication. It is not necessary for a user or a server to request upgrades. The widget receives files from chat server 160 dynamically. If new features are available on chat server 160, they are automatically loaded when the website where the widget 131 or its copies resides is reloaded.

The software code may be an embedded Flash, JavaScript, a browser plug-in, or a Java routine. One such Flash embodiment includes using the LocalConnection Objects in Flash to interact between SWF files. The LocalConnection class allows sending and receiving of data from one SWF to another across sites. Cross-domain communication is enabled through commands such as LocalConnection.allowDomain( ). Sites that include this Flash script communicates with the intended domain to transfer information.

A JavaScript embodiment includes dynamically embedding a script tag on a page. By dynamically inserting a script tag on a page, the JavaScript is run immediately. The script tag references scripts on other sites. To facilitate communication between the dynamically embedded script and the other domain, the included script outputs a JSON (or any other predetermined format) response to the data contained in the URL of the script tag.

A second embodiment includes a downloaded and installed software application, like a browser plug-in, where the installed application affords a greater range of functionality than a stand-alone browser normally allows. The application is an installed extension of the browser like a Mozilla Add-on, or a separate application altogether. Once a user installs such a plug-in or similar application, the installed software has the ability to detect what website a user is browsing and communicate that and similar information to non-guest server 150 via a protocol like HTTP or a connection using another type of Internet protocol.

Another embodiment involves embedding a small program, perhaps in Java, called an applet onto pages served by website server 130 using the <applet> tag. The applet is downloaded every time the user visits the page and the code is executed by software on the user's computer, which can be the Java Virtual Machine, etc. When the code is executed, the applet is able to garner pertinent information which can then be communicated back to non-guest server 150 via HTTP or another Internet protocol.

The user of A.COM's website may have his/her presence known in many ways. For example, an icon for a popular website may appear next to the user's name on user of group chat user interface 121, such as a “Y!” for “Yahoo.” It may also show the name of a website in its usually known name, such as “Yahoo,” or by a hyperlink www.yahoo.com which may appear when a mouse pointer moves over an icon. The user of group chat user interface 121 may receive an e-mail, instant message, text message or other method of notification of user of group chat user interface 111's web presence. A user may choose one or more ways to notify another user his/her web presence. A user may choose one or more ways to be notified of another user's web presence.

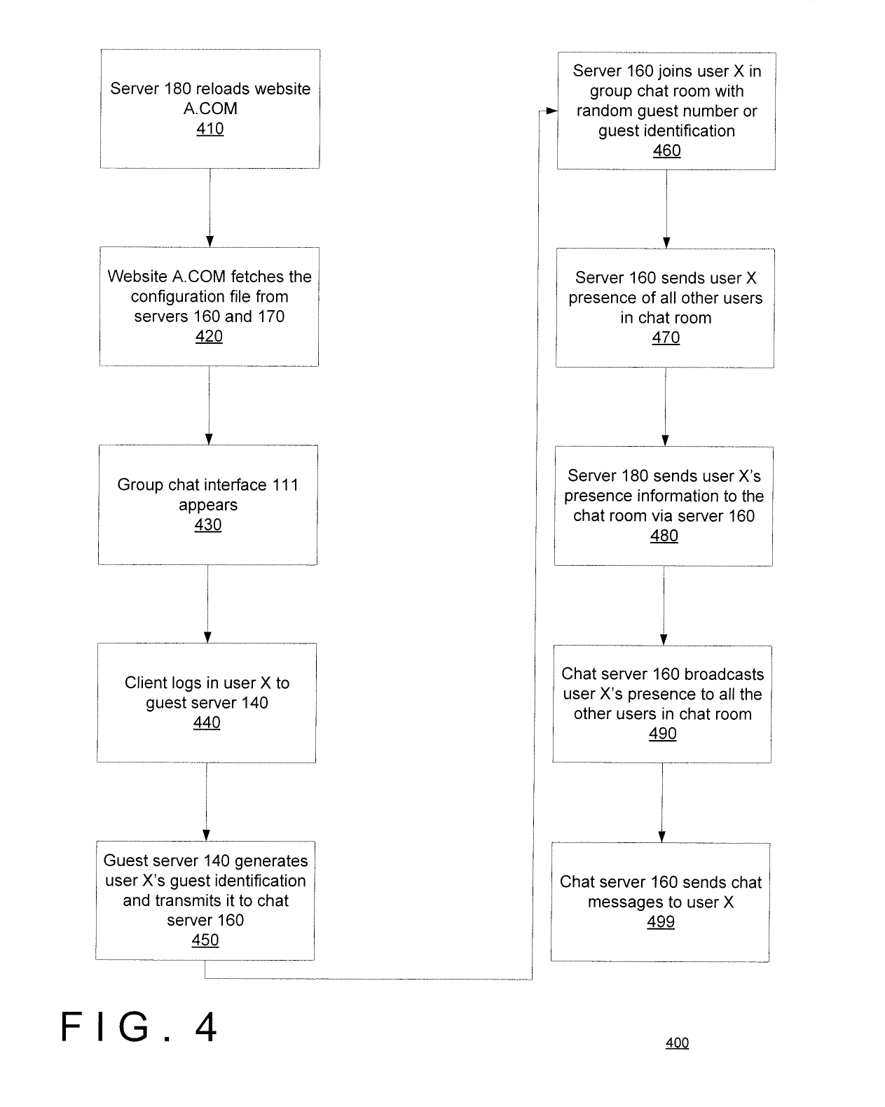

FIG. 4 illustrates a flow diagram of an exemplary process 400 for a user to join an embedded group chat room through a third party website, according to one embodiment. When a user, e.g., user X, visits the website A.COM on client 110, the widget 131 embedded on the website is loaded (410). Depending on the user's browser, the widget 131 is automatically loaded when the website 110 is loaded or the visitor must activate it. Activation can be accomplished by clicking a button on website 110, scrolling the website 110 so that the representation of widget 131 comes into physical view, etc. When website A.COM is loaded, the server hosting website A.COM, assuming its name is 180, may fetch the configuration file pointed by the widget from configuration server 170 (420). The configuration file identifies the user associated with the widget 131, visual preferences for the user, title, alias, and other information that the widget 131 might need for instantiation. With the parameter information contained in the configuration file, a group chat interface 111 is created on website A.com, which is very similar to the group communication interface 121 on group chat interface 120 (430).

The group chat interface 111 has a particular title, color scheme, and a presence or status element indicating information about the owner of the group chat room (set to offline as a default). Interface 111 has embedded code that allows widget 131 to be copied and may render a “Copy” button on interface 111. By clicking on the Copy button, an owner or manager of a website may copy this widget by embedding the presented embed code into his/her website. Thus each group chat interface easily allows the group chat room to spread to other websites.

A client device logs in user X to guest server 140 (440). Guest server 140 generates a random general guest identifier, e.g., the alias of “guest108”, and transmits the information to chat server 160 when user X requests to join a particular chat room (450). This general guest identifier is unique and may be used throughout the system. In the event that another client tries to use the same identifier, another one is generated or user X is prompted to select a different identifier. Many group chat rooms may be hosted by the chat server 160 and available for user X to join. When user X joins any particular chat room, the chat server 160 or guest server 140 may generate another random identifier for the user to use specifically for this particular chat room. Alternatively, user X may use the original number guest 108 across different chat rooms (460). User X may change his identifier anytime during the chat session, as long as the new identifier is not already in use. Once user X joins a particular chat room, chat server 160 sends user X the presence information of all the current users in the chat room (470). User X also sends his or her own presence information to chat server 160 (480). Server 160 then broadcasts user X's presence information to all the other users in the chat room (490). User X is now able to communicate with multiple users in the chat room, and chat server 160 may send user X a chat message (instant message) from another user, or user X may send user X's chat message to all the other users in the chat room (499). Chat messages may be in the form of text, images, videos, interface changes, advertisements, etc.

In one embodiment, a user in a chat room may send private instant messages to other users in the same chat room. For example, an existing user in the chat room may send user X an instant message welcoming him or her to join the chat. This message may be sent via user X's general guest identification number guest108, or the specific guest identification number used only in the particular chat room. Because the private messages are sent via the chat room server 160, it avoids problems with firewalls when sending messages from different websites may encounter. User X may choose to block all private messages or selectively choose messages to allow or disallow.

In yet another embodiment, server 160 may aggregate presence information and messages, and send chunks of information together at fixed or flexible intervals. For example, a user with guest identification number guest102 may join the chat room first, another user with guest identification number guest103 joins ten seconds later, and a third user with guest identification number guest104 joins another 5 seconds later. Instead of sending their presence information to the existing users in individual messages, the server 160 may throttle and send the presence of these three new users together in one message. Throttling may also apply to the sending and receiving of chat messages.

In yet another embodiment, a user's ability to conduct activities in a group chat room is well-controlled. For example, the owner of the group chat room may have the ability to determine other users' privilege or status level, grant special permission for a particular user to join even when the maximum number of users in a group chat room is reached, kick out or ban users utilizing user name or IP address, post media, configure a group chat room, invite new users to join, show the web presence of users in the group chat room, make a group chat room public or private, and/or flag contents to be removed. The owner of a group chat room may assign certain users to become moderators who may enjoy some or all of the privileges the owner has to control the activities in the group chat room.

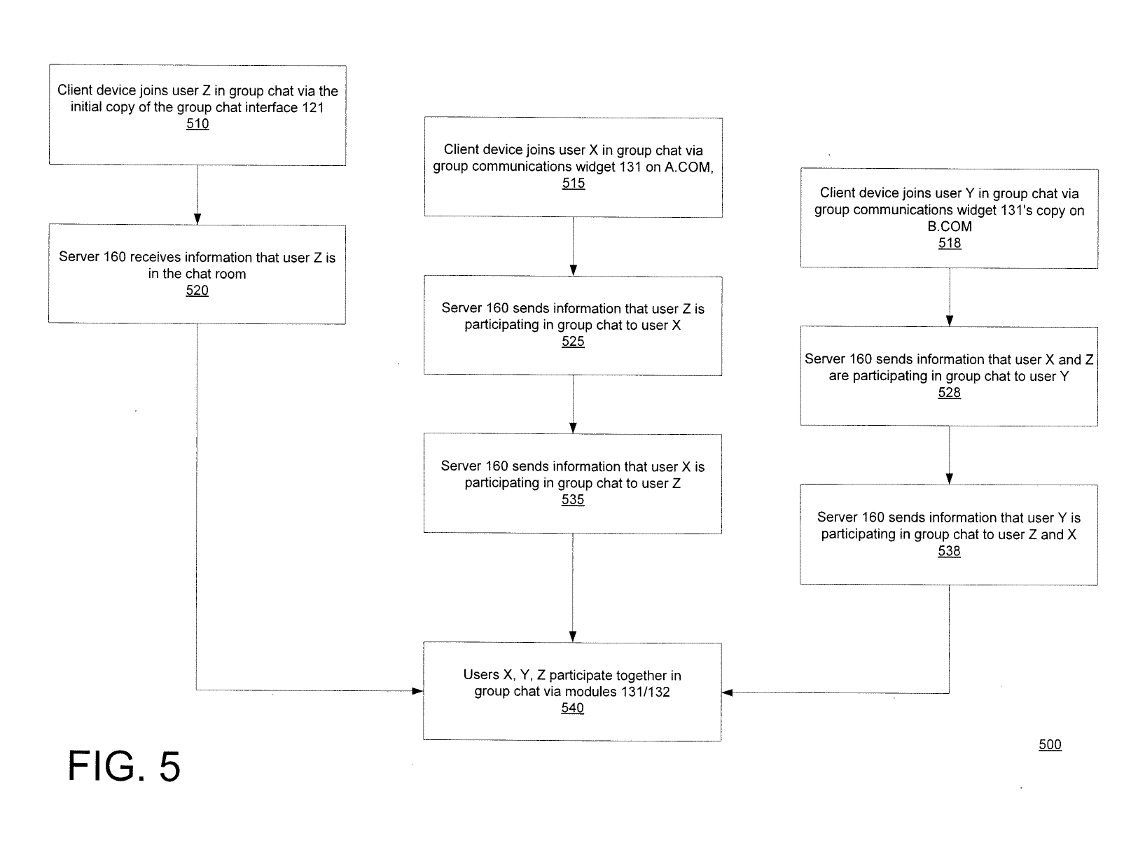

FIG. 5 illustrates a flow diagram of an exemplary group communications process 500 in real time from many different websites, according to one embodiment. A user Z joins the system from a client device. User Z creates a chat room thus is the first user in the chat room (510). In another embodiment, the act of joining a room may create the chat room; the resulting chat room may be temporary or persistent. Through the procedures described above in FIG. 4, client device joins user X in the chat room from interface 111 on A.COM (515), and some time later user Y joins the chat room through another interface on B.COM (518). When X joins the chat room, server 160 immediately sends X the presence information of user Z (525). Server 160 then sends user X's presence information to user Z (535), and starts routing any public or private messages sent from the two users (540). When Y joins the chat room, server 160 immediately sends Y the presence information of both X and Z, who are already in the chat room (528). Then server 160 sends presence information of Y to both X and Z (538), and starts routing public and private messages involving Y (540). In this embodiment the server may also send some limited set of the chat history for the room in order to give newly joined users more conversation context. The history may include text, images, multimedia, advertising, or anything else that occurred in the room before or at the time a user joined.

In one embodiment, a guest user may log into guest server 140 using an ID that is used on another website. For example, Jabber guest server 140 may allow users of MySpace.com to log in using the MySpace.com IDs. A guest user may thus appear as XXX@myspace.com in messages and on buddy lists. If the ID is already taken, a similar ID may be generated. When a login process takes place through a third party website, the widget embedded on the third party website renders the group chat interface that communicates with the chat server 160 and third party server. A configuration file is fetched from the configuration server 170 for the parameters of the group chat room. In addition, user information may be fetched from the third party server by the widget using a particular URL, e.g., http://myspace.com/get_user.php, that is stored in the configuration file and can be set during the creation and modification of the chat room by the owner or an administrator of the system. The guest user may have different privilege levels afforded by the chat server 160 or the third party server. The guest user's name on the group chat interface or buddy list may contain a link to its user profile at MySpace.com or other information on the MySpace.com website.

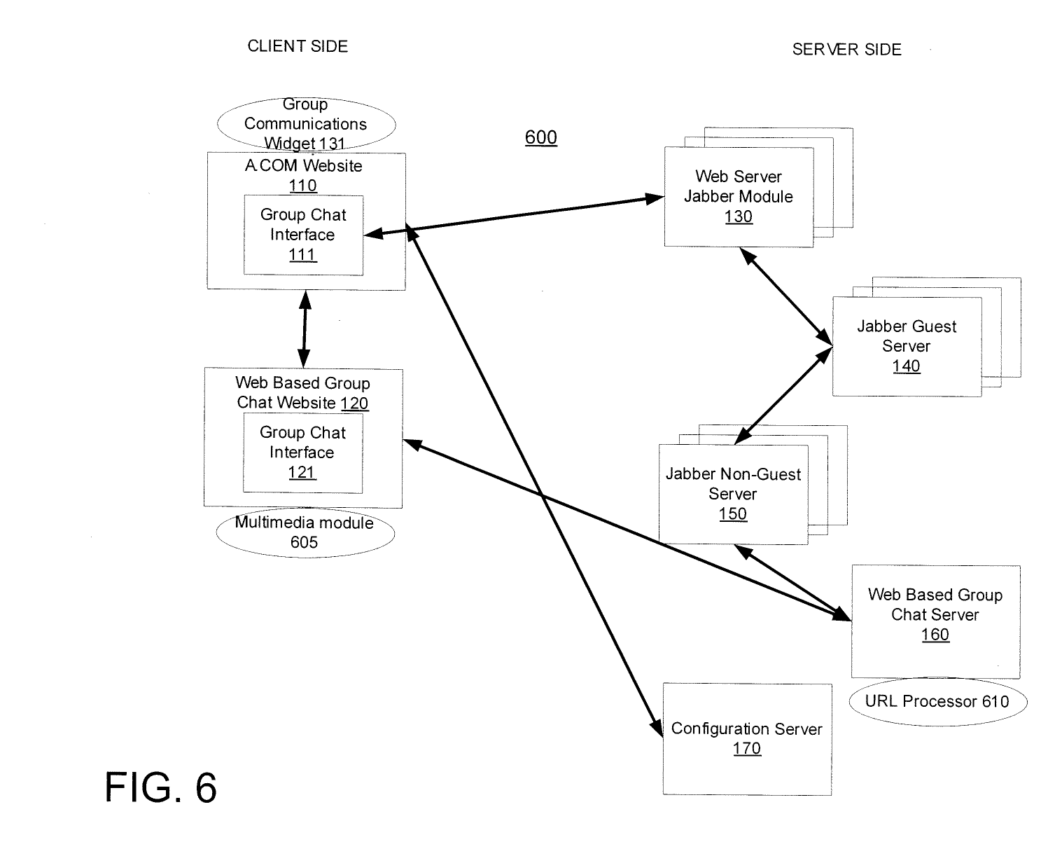

FIG. 6 illustrates a block diagram of an exemplary peer-to-peer group communication system with a dynamic multimedia module, according to one embodiment. System 600 includes a dynamic multimedia module 605 that is linked to widget 131. Dynamic multimedia module 131 may reside on group chat interface 121 and it may also be integrated in widget 131. The system also includes a URL processor 610, which may reside on group chat server 160, or any other back end server that is connected with the group chat server 160. The URL processor 610 is capable of detecting a URL link, and deciphering the location of the media source from which to render the media item.

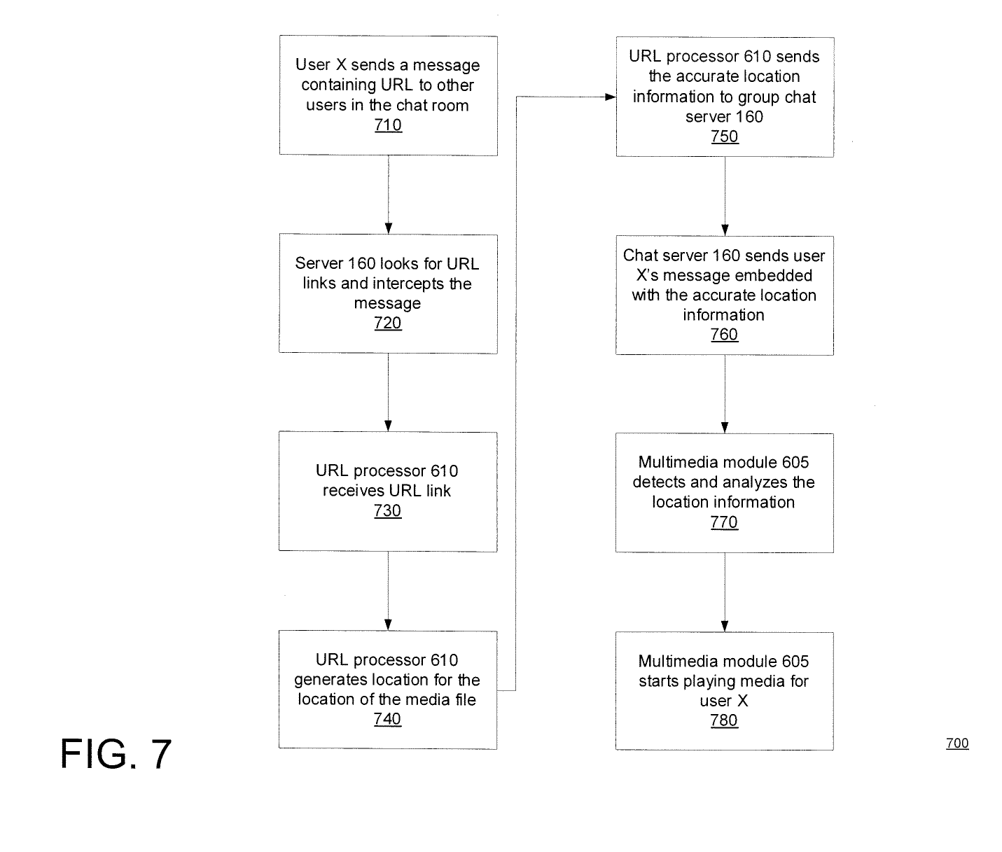

FIG. 7 illustrates a flow diagram of an exemplary process 700 for delivering real-time dynamic media in a group chat room, according to one embodiment. User X sends a message to the chat room with a URL linking to a YouTube video of an exciting soccer match (710). This message can be delivered in a number of ways, including a normal text IM or using a custom UI element like a button, etc. Server 160 detects this URL and sends the link to the URL processor 610 (720). This URL may not point to the actual location of the media file. For example, the media may be a video on YouTube.com. The URL link refers to the website where the video resides, but may not contain the information of the exact location of the video file on the website. There may be multiple media files on this particular website. In addition, some websites do not contain the media files, only links that refer back to another website where the media files are actually located. After the URL processor 610 receives the URL link, it analyzes the link and if necessary, generates a second URL for the actual location of the media file (640).

The URL processor 610 may decipher information of content type, such as whether the media is a video, an image or an audio file, the source website's original URL, the thumbnail URL, and any other information related to the media source. Sometimes the URL processor 610 may have to load the website where the media file actually resides to obtain such information. Some of the information may be removed and saved in a log residing on the group chat server 160 before the actual location information is generated and distributed. One method for the URL processor 610 to decipher actual location information of a media file is to use a database of patterns. The database of patterns may be located on the chat server 160 or any connected back end server. The URL processor 610 then sends the actual location information back to the chat room server 160 (750). Server 160 broadcasts user X's message with the location information, as a clickable URL, or clickable thumbnail image of the media, to every user in the chat room (760). The dynamic multimedia module 605 detects and analyzes the location information and fetches the media file from its location (770). Dynamic multimedia module 605 starts playing the media (780) and it appears in each chat room. If a user is viewing another media file, the user may receive a prompt to start the new media file. In another embodiment, the media player module may render the media source in an altered form than the original source.

The system 600 is also configured to accept an RSS feed that is pushed into the group chat room. RSS stands for “Really Simple Syndication” and is a family of web feed formats used to publish frequently updated content such as blog entries, news headlines or podcasts. An RSS document, which is called a “feed,” “web feed,” or “channel,” contains either a summary of content from an associated web site or the full text. RSS makes it possible for people to keep up with their favorite web sites in an automated manner that is easier than checking them manually. RSS content can be read using generally available software called a “feed reader” or an “aggregator.” Such feed readers rely upon a standardized format for the feed and are able to parse and extract relevant information. The information is then presented to the user in a readable interface; for example, a user may click an RSS icon or link in a browser that initiates the reading or viewing process. The feed reader checks a user's feeds regularly for new content, downloading any updates that it finds. In this embodiment, the dynamic media player module may parse RSS feeds itself or rely on a server side process similar to URL processor 610.

When a media file is located on a network such as the Internet, the chat server 160 may automatically play it for every user in a group chat room synchronously. Each user in a linked group chat room may hear, read, or view the media content at the same time in a synchronized way. The ability to post a particular media file may be restricted by membership levels, history of participation, like or dislike of the chat room owner, position in a queue of the media file, or similar criteria. Synchronization may be displayed to the user in a number of different ways, including a shared icon, text messages, etc. The synchronization scheme can depend on a number of criteria, including active viewership, membership level, position in the queue of the media files, etc.

A user may play a media file such that it is not shared with other group chat users. A user may send instructions to the dynamic multimedia module 605 to stop playing a media file that others are viewing synchronously and may choose to play another media file individually. In one embodiment, a user may delay, replay, rewind the media file that is being played, allowing more discussion on particular segments of the media. When a media item is played to all participants of a group chat room or to a group of the users in the group chat room, if one or more users choose to delay the playing of the media, that user's player is no longer synchronized across the group chat room. A user may re-synchronize with the original playing of the media file. If a user joins the chat room late, e.g., such that the other users have already viewed two media files and are currently viewing a third one, the dynamic media player may not play the first media to the newly joined user from the beginning. Instead, the dynamic media player may start the new user at the third media or the fourth media, depending on the length of the third media and how long it has been played to other users. In this embodiment, the media player module may loop each individual user's play list, i.e. when the last media item is played and no new media has been added, the player starts playing the very first item. In one embodiment, if the user has not opted out of synchronizing, whenever a new media item is added the media player may jump to the newest item.

In another embodiment, the backend server responsible for synchronizing media files loads the media file and determines the length of the media source. In this scheme, media files for the new user may start playing at the exact point that other synchronized users are playing. In another synchronization scheme, users may customize their own play lists and synchronization may occur for different subsets of users, as opposed to all participants in the room.

In one embodiment, the chat server 160 keeps chat logs. The chat logs are maintained on the group chat server 160 or a separate chat log server. It contains information such as the nick name of the users, time a message is sent, the actual content of the message sent, the links to media files that have been sent, the media files that have been pushed into the group chat room, the media files that have been played, and the advertisement that has been viewed by users. These chat logs may be permitted based on the ownership of the room, the public or private nature of the room, or other similar criteria. Chat logs can be rendered on widget 131, chat interface 121, or another separate website altogether.

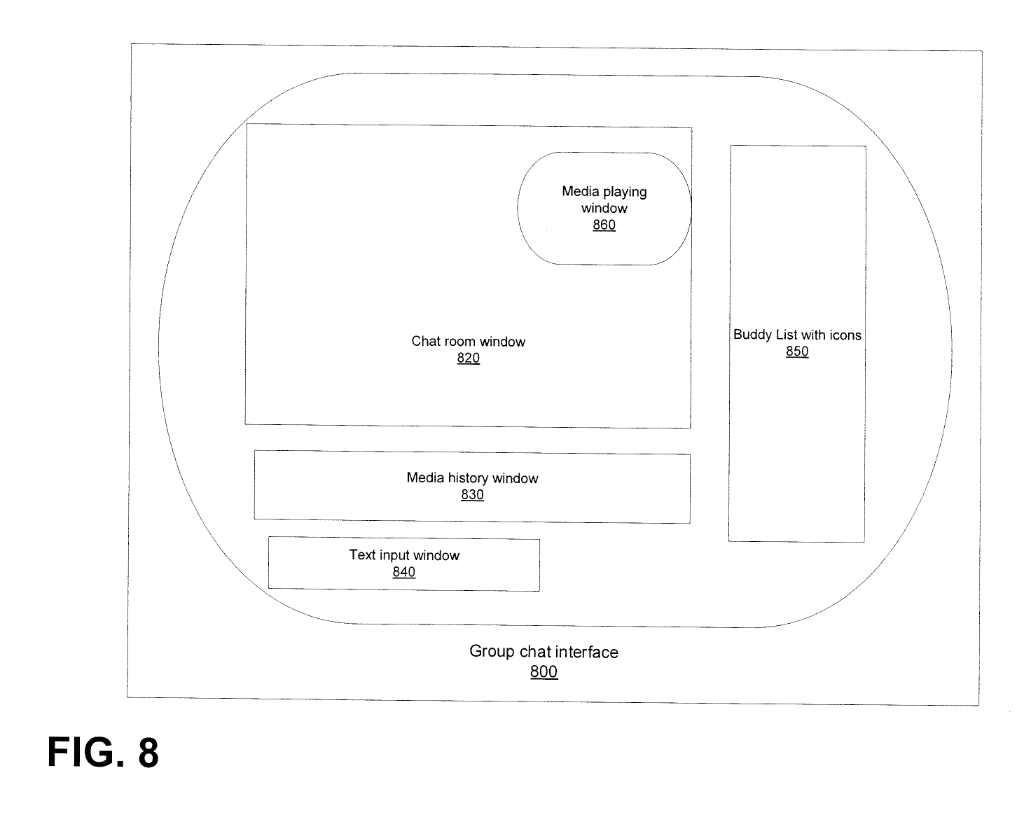

FIG. 8 illustrates an exemplary user interface 800 for delivering real-time dynamic media, according to one embodiment. In this embodiment, the text input window 840 for users, where any user can view what he or she has entered, is at the bottom of the interface 800. The chat room screen 820, where one can see on-going discussions of many users, is central. The media playing screen 860 is a smaller window embedded in the chat room window 820. The media history window 830 may be in between the chat room window 820 and the text input window 840, or right next to the media playing window 860. The buddy list 850 of any user is located as a column at the side of the interface 800. Any user may rearrange the layout of its computer screen or maximize or minimize any one of the windows described above according to his or her preference.

A media file may be displayed anywhere within the group chat room user interface (e.g., 810), at the side or bottom, in a special smaller window 860 that floats on the chat room 820, or in a pop-up window. It may also appear between lines of instant messaging chats among the users. In one embodiment, media files played by users in the group chat room may be listed in media history window 830, allowing users to easily resume or return to favorite media files. For example, it is likely that a group chat room discussing movies has users who discuss the same movie, or the same scene of the movie repeatedly.

In one embodiment, chat server 160 detects each user's presence and participation history so as to grant them different media searching and playing capabilities. Different clients may contain cookies with users X, Y and Z's identification information. Chat server 130 may contain a program to detect such cookies. Identification and presence information may appear on the buddy list 850.

Servers hosting websites 110 and 120 update their respective user interfaces 111, 121 to indicate that the users are both available. Real time status of each user is maintained. For example, if the user on interface 121 leaves the chat room or even logs out of the guest server or non-guest server, user interface 111 is updated to show the “away” status and the associated message. User interface 121 also indicates that the other user is using the embedded widget associated with a particular identity. This identity can be a category (e.g., “Social networking”) as specified by data read in from the configuration file. The identity could also indicate the website (e.g., A.COM) where the widget is embedded. This could be done using the configuration file, running a CGI script located on another web server that responds with the containing website, or another implementation that accurately returns the embedded website.

If the user on website A.COM 110 leaves the chat session without explicitly closing the session (e.g., close the browser, leave the website, etc), after a pre-set timeout (e.g., 45 seconds in one embodiment), the server 160 assumes the connection to client 110 is lost. The connection can be reestablished. If the website on A.COM 110 is reloaded, if a group chat session was already established, it will be terminated and restarted, according to process 300 and 400.

If the user on website A.COM 110 attempts to contact user of group chat user interface 121, but the user of group chat user interface 121 is not logged in, the user on website A.COM 110 may still send a message. This message can include an initial subscription request. The message will be stored on the Jabber non-guest server 150 and then served to the user once he/she logs in. In the case of a cached and delayed subscription request, chat server 160 still automatically accepts the request once the user is logged into interface 121. Before this occurs, the visitor on user interface 111 sees the widget owner as offline; once the subscription is completed, the interface 111 is updated to reflect the widget owner's new status. If the delayed message is in the form of an instant message, the user on interface 121 can respond if the Jabber user on interface 111 is still available and present on the website 110. In one embodiment, messages sent from the registered Jabber user on web server 160 using interface 121 to the guest Jabber user on interface 111 are discarded if the guest user has terminated the session before the message is received.

A user of the widget 131 may terminate the connection to a group chat room at any time by clicking on a disconnection group chat user interface 111. This effectively closes the network connection, ends communication between this user and all other users of the chat room, and terminates future notifications of presence. To all other users of the chat room, the first user appears offline. Visitors to website A.COM 110 may ignore the owner of widget 131 in the event of unwanted conversation and browse the page anonymously. The widget 131 remembers the visitor's preferences and uses them for subsequent visits to the website 110. In one embodiment, the visitor's preference can apply to group chat interface 121 or others on all web pages, not limiting to a specific instance. The preference information may be stored in a cookie as part of the widget or on the group chat server 160.

The widget 131 on website A.COM 110 may also track the time that a user is visiting website A.COM and send that information to the user on group chat user interface 121. The session length and similar information may be stored at server 160 for analysis and generation of metrics (including advertising metrics).

A cookie may be stored on a client device to track the frequency with which the client logs into A.COM 110. The cookie may also be used to store an alias for the user using the client. A hash algorithm may also be used to assign a unique identifier to the client that is stored on web based group chat server 160. Additionally, if a user opens additional browsing panes or windows, group chat sessions that have been established are not dropped.

In one embodiment, a user on A.COM 110 may voluntarily close the session using interface 111, thus terminating his or her participation in the group chat. The status of the guest Jabber user is then updated on user interface 121. If the website is not reloaded and the guest user establishes a new session, the same guest account is used by web server 130 (and Jabber guest server 140) and therefore the user interface 121 treats the presence information as coming from the same user.

In another embodiment, the same temporary guest Jabber user account is used despite page movement or reloading by the visitor to A.COM 110. Users of interface 111 can browse sub-pages of a website 110 while maintaining their connection to web server 130. The group chat user interface 121 or the Jabber non-guest server 140 might display information about the guest user's browsing behavior or other related information. One way this could is achieved is by storing the visitor's configuration credentials in a cookie or another browser storage related method. Another embodiment might involve communication with the servers of A.COM to store session information.

In another embodiment, a bot is used in a group group chat room. A bot is generally a computer program that simulates human conversation to communicate with a real person. A bot feature enables a computer to communicate with other users on behalf of user X. In this embodiment, a bot is a software module that is part of the group communications widget 131. User X may activate the bot feature to communicate with other users when user X is busy or unavailable. The bot may be used to answer frequently asked questions, inform visitors when user X will be available to chat, may be used in a business context such as answering questions about an item for sale, or for other similar information. The bot may also serve as a mechanism for group user games, such as trivia games.

In another embodiment, a user may also create an avatar to provide other users visiting one or more of his/her websites with a graphical representation of the user. The widget 131 may render a user's avatar on websites linked to the widget 131 to enable other users to view a graphical representation of the user.

In yet another embodiment, a mobile service module is contained in the chat server 160 to allow a user to join the chat room using a mobile device. If the mobile device is similar to an iPHONE which contains a full-service browser, any user may take full advantage of the group chat room through the full-service browser.

For mobile devices without a full-service browser, the mobile service module on chat server 160 recognizes messages from an address that appears as phonenumber@carrier.com similarly as it recognizes an email address. Guest server 140 and non-guest server 150 may contain or connect to databases with users' identification names or numbers that correspond to an e-mail address or a mobile device address. For non-guest users, the chat room server 160 may fetch the information from a database associated with the non-guest server 150; for guest users, the chat room server 160 may fetch the information from a database associated with the guest server 140. The mobile service module on group chat server 160 may translate the message from the mobile device, which is similar to an e-mail, into a text message to be pushed to the group chat room. The message pushed into the group chat room may appear like a regular chat message or a system message. In some situations, the user may not be able to participate in the group chat room fully, only using the chat server 160 as a mail server to update the user's friends of his or her whereabouts.

In yet another embodiment, the system 100 contains a game-playing software module. The game playing module may reside on group chat interface 121, or be integrated into widget 131 and its copies on different websites. The game module allows users to join a game from multiple websites similar to the way users join a chat room through different websites. No install of a game from the Internet is required for playing a game this way. The widget 131 on website may communicate with a copy of the widget 131 through group chat room server 160. The widget of one user may also communicate with all the other users in the group chat room through group chat server 160.

In another embodiment, the system 100 contains a general application framework so that any type of software module that abides by a pre-determined API can live on group chat interface 121 or interface 111. The software module may use similar communication protocols that the chat interfaces uses or one determined by the API.

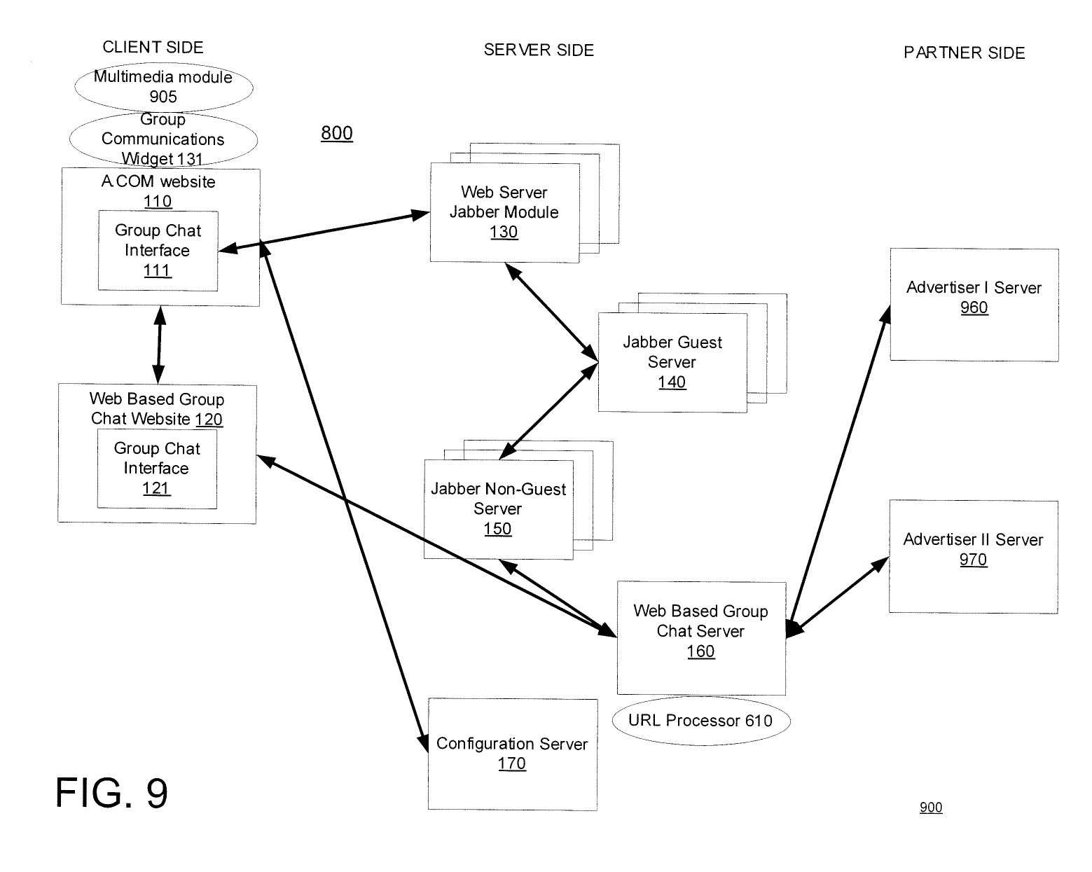

FIG. 9 illustrates an exemplary peer-to-peer group communications system 900 with dynamic advertising, according to one embodiment. In one embodiment, third party advertiser I server 960 and advertiser II server 970 communicate with group chat server 160 to provide advertising data to users in the group chat room and the websites where the individual chat room resides. Advertiser I server 860 and Advertiser II server 870 may be servers owned by any corporation, governmental organization, individual, or non-profit organization. For example, advertiser I may be the Federation Internationale de Football Association (FIFA) that wishes to advertise soccer-related events and Worldcup soccer memorabilia. System 900 allows FIFA to target users of a particularly active group chat room devoted to the Worldcup. Advertiser II may be a large sporting goods retailer who targets the same audience to purchase soccer merchandise.

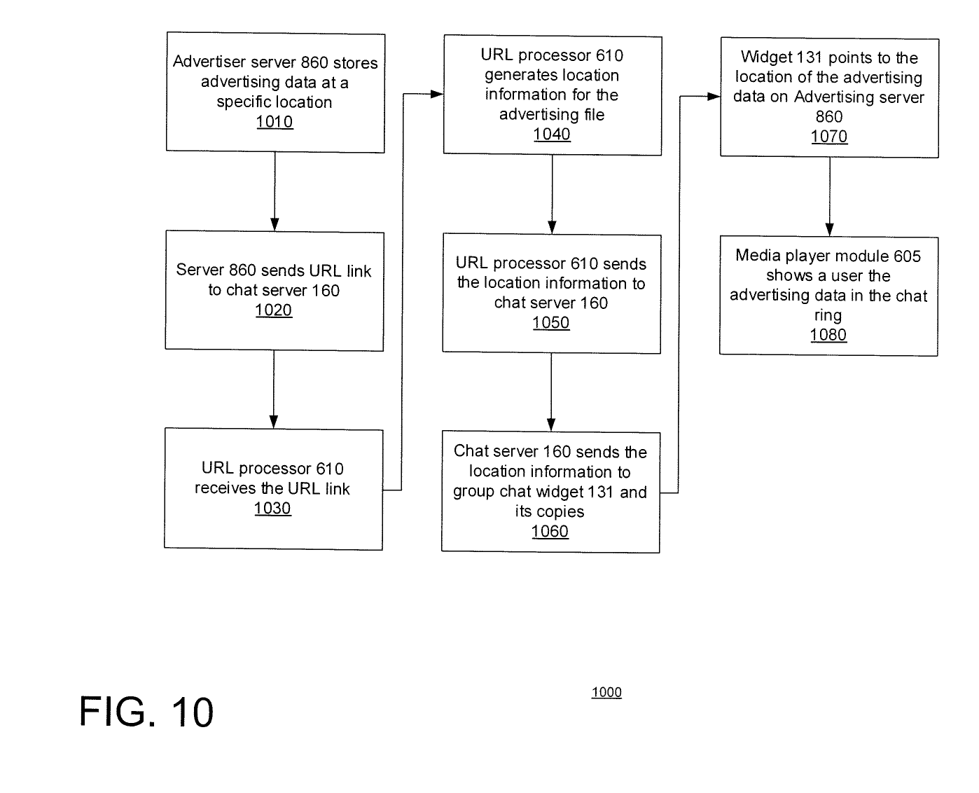

FIG. 10 illustrates a flow diagram of an exemplary process 1000 for providing advertising data to a group chat room, according to one embodiment. In this embodiment, advertiser I may design and maintain different advertising data and stores them at different locations on advertiser I server 860 (1010). Advertising files are media files. The process for group chat users to access advertising data on advertiser servers is similar to the process of accessing media file on the internet. Advertiser I server 860 sends the location information of an advertising file in the format of a URL link or similar formats to one of the back end servers. The back end server receives this information may be group chat server 160 or other another server connected to group chat server 160 (1020). Similarly, a URL processor 610 is located on group chat server 160 or a connected server. A URL processor 610 detects and processes the URL information to generate the exact location information of the advertising data file (1030, 1040). The URL processor 605 then sends the location information of the advertising file to group chat server 160 (1050). Server 160 then sends the location information to all the connecting group communications widgets 131 or it copies (1060).

The location information of advertising data file may be incorporated into the widgets, which then contain an unique address of the advertising data on the advertising server 860 (1070). The group communication system 900 also contains a media player module 905 which may reside on group chat server 160 or be integrated as part of the widget 131. In one embodiment, the media player module 905 is integrated as part of the widget 131. It may play the advertising file as a media file (1080). The advertiser may update the content of the advertising data regularly by storing new advertising file at the same location on advertising server 960. Thus the address of the advertising data remains the same but the content changes. For example, FIFA may update the advertising according to the progress of a soccer game, featuring different soccer stars according to their performance in the game. The media player module 905 with widget 131 may play the advertising file by pointing to the same address on advertiser server 960 and fetching the advertising file at the address, but ending up playing different advertisement as advertiser updates the advertising data. Similar to system 600, the advertiser may also provide advertising data to users in the form of RSS feed.

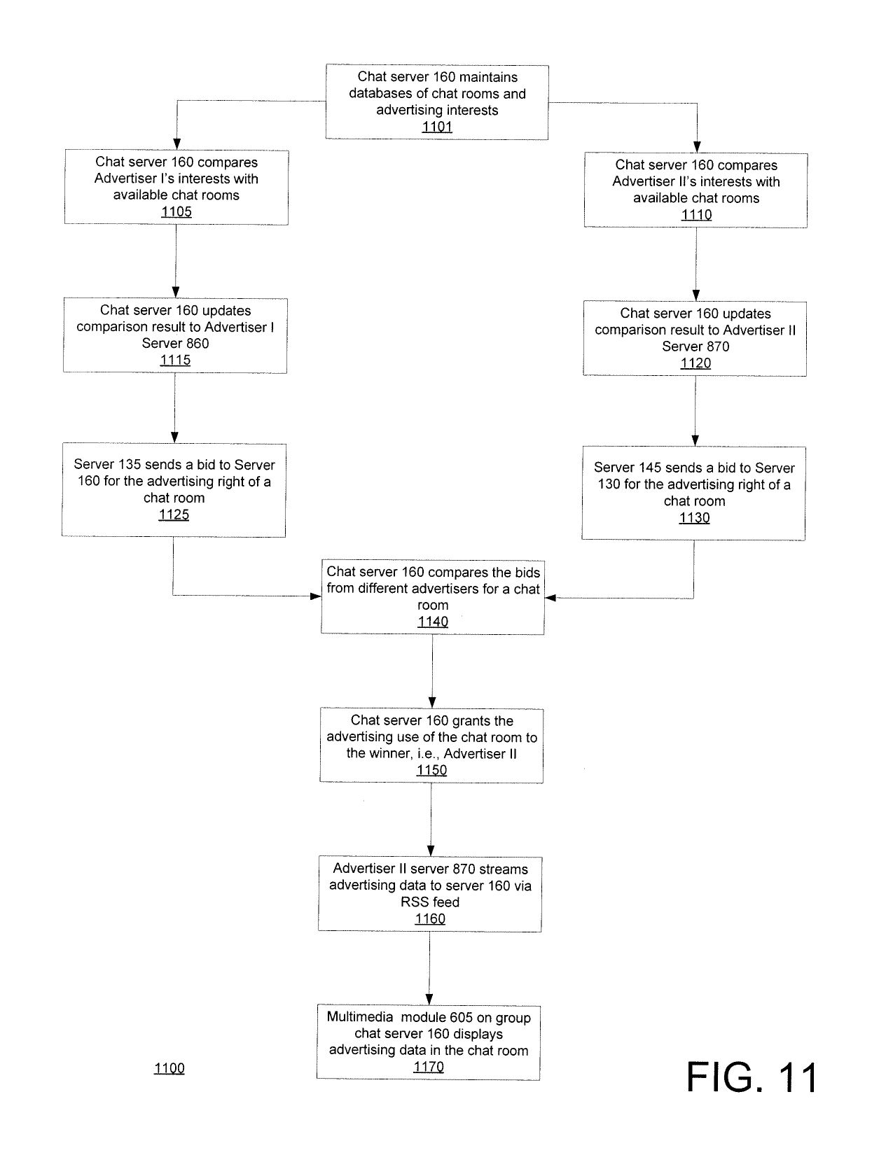

FIG. 11 illustrates a flow diagram of an exemplary process 1100 for advertisers to acquire advertising space in a group chat room to conduct real-time dynamic advertising, according to one embodiment of the present invention. In this embodiment, system 900 includes a database of chat rooms/group chat rooms that it hosts (1101). This database may reside on group chat server 160 or a connected backend server. The system 900 also includes a time slot database for all the group chat sessions it hosts. For example, it may divide a Worldcup discussion chat room into 5 minutes time slots and an interior design discussion chat room into 30 minutes time slots.

In another embodiment, other databases are included in system 900. One database contains set prices for the advertising rights of different group chat rooms for different time slots. Another database contains the interests of different advertisers. These databases may reside on group chat server 160 or a connected back end server (1101). Server 160 compares advertiser I's advertising parameters with group chat rooms that are available for advertising (1105). For example, Advertiser I is FIFA and is interested in targeting any chat rooms devoted to soccer. After comparison, server 160 sends the result to advertiser I server 960 (1115). Accordingly, in one embodiment, advertiser I server 960 provides advertising dynamically to server 160 and distributes the advertising content to all instances of the chat room. Advertiser I (through its server 960) may bid on advertising space, and chat server 160 aggregates the bids. This process may be automatically run by advertiser I server 960 or initiated by live agents of advertiser I.

A parallel process takes place with group chat server 160, advertiser II server 970 with processes 1110, 1120, and 1130. Advertiser II server 970 also sends a bid to group chat server 160 for the same group chat room. More than two advertisers may be interested in the same chat room or the same time slots in a chat room.

After server 160 compares the bids (1140), it grants some of all of the advertising space of group chat room to the winning advertiser, for example, Advertiser II (1150). Advertiser II server 970 streams advertising data to the group chat interfaces (1160). Media player module 905 displays the advertising on some or all the group chat interfaces in a group chat room.

Group chat server 160 or a connected back end server controls time allocation of advertising slots to different advertisers. In one embodiment, the highest bidder wins the right to advertise in a particular chat room for a segment of time. For example, time slots may be allocated by years, months, days, minutes or seconds. Bidding among advertisers may take place frequently. This way each advertiser can adjust its bidding according to the need for advertising in a dynamic fashion.

Advertising information may be displayed anywhere within the group chat interface 111 or 121, at the side or bottom, in a special smaller screen that floats on the chat room, or in a pop-up window. It may also appear between lines of instant messaging chats among the users, with different fonts or colors of text to differentiate the advertisement from users' messages. In other words, the advertiser may be a chat room participant, inserting advertisement in real time. The streaming of advertising data is live and instantaneous. For example, when a soccer game is playing, an advertiser such as ESPN may stream the scores live to the advertising space of the ring of chat rooms. If the discussion in the chat room centers around a famous soccer star, advertiser II server 970 may stream advertisements with this soccer star's image. If the discussion turns into playing soccer in winter, server 970 may stream an advertisement of winter sporting outfits.

In one embodiment, server 160 may have a self-learning software that learns a particular user's interests in merchandise through the user's past surfing or purchasing history. For example, past history may have shown user X as a soccer fan, particularly an admirer of a particular soccer star. Advertisement depicting this soccer star may be shown to him. Past history may have shown user Y as a soccer fan that follows one team in Europe. Advertisement based on this team may be shown to him.

In yet another embodiment, the group chat room may play advertising data to particular users depending on the geographic location of the users, location or language format of the websites hosting the chat rooms. For example, an advertiser like FIFA may prepare different language versions of the same advertisement to be played during a Worldcup final game. Group chat room server 160 detects the location of the website where a particular group chat interface is through the widget 131 on this website. Group chat server may also detect which language is used for discussion in a group chat room. For example, one group chat interface in the chat room is hosted by a website that is in Russian. The system may show the Russian version of the advertisement to the user using this group chat interface. Another copy of the group chat interface is on a website that is hosted on a server in China. The system may show the Chinese version of the advertisement to the user using group chat interface. Language translation may also be provided in real-time, so group chats in multiple languages can occur.

In yet another embodiment, the group chat room may play advertising data to particular users depending on users' age, gender, past interests, surfing history, and similar information. The non-guest server 150 and the guest server 140 may collect information such as age, gender, interests of the guest users and non-guest users when they join the group chat room. A surfing history and a history of participation in different topics of group chat may also be collected. The collection of the information may be anonymous or with permission from the users. The system 900 may direct different versions of the same advertisement, or different advertisements based on the above collected information.

The system may also enable advertisements based on the number of users who have viewed a particular advertisement in a particular period of time for at least a certain number of times. For example, a summer clothing advertiser may want to target female users at a certain age three times within the month of April. Serving the targeted advertisement may continue until one million users in the targeted age group have been shown this particular advertisement. Additional advertising serving rules allow a particular advertisement to be served a predetermined number of times during a predetermined time period.

The system may also enable targeted advertising directly to users on a website where a copy of the group communications widget is embedded, even if the users are not participating in group chats, but are only surfing the website.

The detection of a user's presence by chat server 160 and potentially by servers of the advertisers may be accomplished in many ways. For example, clients may contain cookies with users identification information. Group chat server 160, guest server 150, or non-guest server 140 may contain a program to detect such cookies. A buddy list may be used. The identification information may be in the form of login name, account number, nickname, e-mail address, instant message ID, or similar information. Guest users may randomly be assigned a temporary guest identification number for the duration of their participation in group chat sessions, or these users may choose a nickname for the duration of their participation. The guest identification number or nickname may accompany a visitor if the same client device and same browser is used for future visits of websites linked to the chat server 160.

A method and system for embedded group communication have been described. It is understood that the embodiments described herein are for the purpose of elucidation and should not be considered limiting the subject matter of the present patent. Various modifications, uses, substitutions, combinations, improvements, methods of productions without departing from the scope or spirit of the present invention would be evident to a person skilled in the art.

We claim:

1. A computer-implemented method, comprising:
providing software code to be embedded in a first website;
loading the first website including the software code;
fetching a first configuration file from a configuration server in response to the software code;
rendering a first group chat user interface on said first website;
providing the software code to be embedded in a second website;
loading the second website including the software code;
fetching a second configuration file from the configuration server in response to the software code; and
rendering a second group communications user interface on the second website.

2. The computer-implemented method of claim 1, further comprising:
providing the software code to be embedded in a third website, the software code being provided by the second website;
loading the third website including the software code;
fetching a third configuration file from the configuration server in response to the software code; and
rendering a third group communications user interface on the third website.

3. The computer-implemented method of claim 2, further comprising allowing real-time communications between the first group communications user interface, the second group communications user interface, the third group communications user interface, and a first server having a Jabber module.

4. The computer-implemented method of claim 2, further comprising
sending first instructions from the first server to a second server, the first instructions establishing an anonymous group chat configuration for a first user using the first group communications user interface;
sending second instructions from the first server to the second server, the second instructions establishing an anonymous group chat configuration for a second user using the second group communications user interface; and
sending third instructions from the first server to the second server, the third instructions establishing an anonymous group chat configuration for the third user using the third group communications user interface.

5. The computer-implemented method of claim 2, further comprising determining if the first user is using the first group communications user interface.

6. The computer-implemented method of claim 4, further comprising prompting the first user to respond to a request from the second user.

7. The computer-implemented method of claim 6, wherein status information for the first user is dynamically updated.

8. The computer-implemented method of claim 6, wherein the first user interface indicates a first location of the second user interface on a network.

9. The computer-implemented method of claim 6, wherein a log of all the communications is maintained.

10. The computer-implemented method of claim 6, further comprising providing a bot to automatically respond to the second user when the first user is not available.

11. The computer-implemented method of claim 8, wherein the first software code includes a media player that plays media files from the network.

12. The computer-implemented method of claim 11, further comprising:
deciphering a second location on the network of a media file;
providing the second location of the media file to the media player;
fetching the media file from the second location with the media player; and
playing the media player the media file on the first group communications user interface.

13. The computer-implemented method of claim 12, wherein the media player plays an advertisement.

14. The computer-implemented method of claim 13, wherein advertising software code allows advertisers to bid for time slots during which the advertisement is played.

15. The computer-implemented method of claim 13, wherein advertising software code allows advertisers to bid for advertising space in a plurality of group chat interfaces having a particular topic.

16. The computer-implemented method of claim 13, further comprising:
calculating a number of times an advertisement has been displayed.

17. The computer-implemented method of claim 13, further comprising, synchronously playing the media file in the first group chat user interface and the second group chat user interface.

18. A computer-readable medium having stored thereon a plurality of instructions, said plurality of instructions when executed by a computer, cause said computer to perform:
providing software code to be embedded in a first website;
loading the first website including the software code;
fetching a first configuration file from a configuration server in response to the software code;
rendering a first group chat user interface on said first website;
providing the software code to be embedded in a second website;
loading the second website including the software code;
fetching a second configuration file from the configuration server in response to the software code; and
rendering a second group communications user interface on the second website.

19. The computer-readable medium of claim 18, having stored thereon-additional instructions, said plurality of instructions when executed by a computer, cause said computer to perform:
providing the software code to be embedded in a third website, the software code being provided by the second website;
loading the third website including the software code;
fetching a third configuration file from the configuration server in response to the software code; and
rendering a third group communications user interface on the third website.

20. The computer-readable medium of claim 19, having stored thereon-additional instructions, said additional instructions when executed by a computer, cause said computer to allowing real-time communications between the first group communications user interface, the second group communications user interface, the third group communications user interface, and a first server having a Jabber module.

21. The computer-readable medium of claim 19, having stored thereon-additional instructions, said additional instructions when executed by a computer, cause said computer to further perform:
sending first instructions from the first server to a second server, the first instructions establishing an anonymous group chat configuration for a first user using the first group communications user interface;
sending second instructions from the first server to the second server, the second instructions establishing an anonymous group chat configuration for a second user using the second group communications user interface; and
sending third instructions from the first server to the second server, the third instructions establishing an anonymous group chat configuration for the third user using the third group communications user interface.

22. The computer-readable medium of claim 19, having stored thereon-additional instructions, said additional instructions when executed by a computer, cause said computer to further perform:
determining if the first user is using the first group communications user interface.

23. The computer-readable medium of claim 21, having stored thereon-additional instructions, said additional instructions when executed by a computer, cause said computer to further perform:
prompting the first user to respond to a request from the second user.

24. The computer-readable medium of claim 23, wherein status information for the first user is dynamically updated.

25. The computer-readable medium of claim 23, wherein the first user interface indicates a first location of the second user interface on a network.

26. The computer-readable medium of claim 23, wherein a log of all the communications is maintained.

27. The computer-readable medium of claim 23, having stored thereon-additional instructions, said additional instructions when executed by a computer, cause said computer to further perform:
providing a bot to automatically respond to the second user when the first user is not available.

28. The computer-readable medium of claim 25, wherein the first software code includes a media player that plays media files from the network.

29. The computer-readable medium of claim 28, having stored thereon-additional instructions, said additional instructions when executed by a computer, cause said computer to further perform:
deciphering a second location on the network of a media file;
providing the second location of the media file to the media player;
fetching the media file from the second location with the media player; and
playing the media player the media file on the first group communications user interface.

30. The computer-readable medium of claim 29, wherein the media player plays an advertisement.

31. The computer-readable medium of claim 30, wherein advertising software code allows advertisers to bid for time slots during which the advertisement is played.

32. The computer-readable medium of claim 30, wherein advertising software code allows advertisers to bid for advertising space in a plurality of group chat interfaces having a particular topic.

33. The computer-readable medium of claim 30, further comprising:
calculating a number of times an advertisement has been displayed.

34. The computer-readable medium of claim 30, having stored thereon-additional instructions, said additional instructions when executed by a computer, cause said computer to further perform:
synchronously playing the media file in the first group chat user interface and the second group chat user interface.
